(19) United States
(12) Patent Application Publication
(10) Pub. No.: US 2026/0171543 A1
(43) Pub. Date: Jun. 18, 2026

(54) INTER-CELL COOLING UNIT FOR A BATTERY, COOLING ARRANGEMENT, MOTOR VEHICLE, METHOD FOR OPERATING AN INTER-CELL COOLING UNIT, AND METHOD FOR PRODUCING AN INTER-CELL COOLING UNIT

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 19/418,013

(22) Filed: Dec. 12, 2025

(30) Foreign Application Priority Data
Dec. 13, 2024 (DE) 102024137695.3

(51) Int. Cl. H01M 10/6557; B60L 50/64; B60L 58/26; H01M 10/613; H01M 10/625; H01M 10/647; H01M 10/6555; H01M 10/6568

(52) U.S. Cl. CPC H01M 10/6557; B60L 50/64; B60L 58/26; H01M 10/613; H01M 10/625; H01M 10/647; H01M 10/6555; H01M 10/6568; H01M 2220/20

(57) ABSTRACT

An inter-cell cooling unit for arrangement between two cell rows, each having at least one battery cell, the inter-cell cooling unit includes a cooling plate unit which has a first cooling plate which includes a first and a second end region which are opposite one another with respect to a first direction, an integrated first cooling duct extending from the first to the second end region, a first coolant supply opening arranged in the first end region, and a first coolant discharge opening arranged in the second end region. The cooling plate unit includes a second cooling plate which is arranged next to the first cooling plate with respect to a second direction and which comprises a third and a fourth end region, at least one integrated second cooling duct extending from the third to the fourth end region.

### FIELD

The invention relates to an inter-cell cooling unit for arrangement between two cell rows, each having at least one battery cell, wherein the inter-cell cooling unit comprises a cooling plate unit which has a first cooling plate which in turn comprises a first and a second end region which are opposite one another with respect to a first direction, at least one integrated first cooling duct extending from the first to the second end region, a first coolant supply opening fluidically connected to the at least one first cooling duct and arranged in the first end region, and a first coolant discharge opening fluidically connected to the at least one first cooling duct and arranged in the second end region. Furthermore, the invention relates to a cooling arrangement for a motor vehicle, a method for operating an inter-cell cooling unit, and a method for producing an inter-cell cooling unit.

### BACKGROUND

Batteries, such as high-voltage batteries for motor vehicles, typically comprise numerous battery cells. These can be arranged in the form of cell stacks or cell rows. A cooling system may be positioned between the cells. Such an inter-cell cooling system advantageously enables cooling of the battery cells on their largest sides in terms of area, which enables very effective cooling of the battery cells.

Ideally, such an inter-cell cooling unit should be as simple as possible, or a cooling arrangement with such inter-cell cooling units should be as simple as possible to manufacture and install, and at the same time it should be possible to provide as uniform a cooling of the adjacent battery cells as possible in order to avoid temperature spreads between the individual cells as far as possible, since such a spread has negative effects on the aging of the battery cells and the power of the individual battery cells.

DE 10 2022 124 276 A1 describes a cell for a high-voltage battery having an inlet, an outlet, and cooling plates which are fluidically connected to the inlet and outlet and which comprise half shells which are connected to opposite sides of a prismatic battery housing of the cell. The half-shells are traversed by axially parallel channels for guiding a coolant.

DE 11 2012 002 518 T5 describes a spacer element which is arranged between two cell units and has a corrugated section. The corrugated section has first and second protrusions, wherein the first protrusions protrude from a center in the thickness direction towards the first cell unit in order to form intermediate spaces serving as cooling channels between the first protrusion and the second cell unit. The second protrusions protrude from a center in the thickness direction towards the second cell unit in order to form intermediate spaces serving as cooling channels between the second protrusions and the first cell unit.

WO 2011/094863 A1 describes a heat exchanger structure for a battery having a first and a second battery stack, each of which comprising a plurality of battery cells. The heat exchanger structure is arranged between the battery stacks and defines one or more fluid ducts. in this case, too, the channels are formed in part by the cell sides themselves.

In cooling systems in which a cooling fluid is to flow through a cooling duct directly in contact with cell housings, the sealing effort is extremely high, in particular if a liquid cooling fluid is to be used.

### SUMMARY

It is the object of the present invention to provide an inter-cell cooling unit, a cooling arrangement, a motor vehicle, a method for producing an inter-cell cooling unit, and a method for operating an inter-cell cooling unit, which permit the simplest possible design of a cooling arrangement and, in particular, cooling of battery cells as uniformly as possible.

This object is achieved by an inter-cell cooling unit, a cooling arrangement, a motor vehicle, a method for producing an inter-cell cooling unit, and a method for operating an inter-cell cooling unit. Advantageous embodiments of the invention are the subject matter of the claims, the description, and the figures.

An inter-cell cooling unit according to the invention for arrangement between two cell rows, each having at least one battery cell, wherein the inter-cell cooling unit comprises a cooling plate unit which has a first cooling plate which in turn comprises a first and a second end region which are opposite one another with respect to a first direction, at least one integrated first cooling duct extending from the first to the second end region, a first coolant supply opening fluidically connected to the at least one first cooling duct and arranged in the first end region, and a first coolant discharge opening fluidically connected to the at least one first cooling duct and arranged in the second end region. Furthermore, the cooling plate unit comprises a second cooling plate which is arranged next to the first cooling plate with respect to a second direction and which comprises a third and a fourth end region which are opposite one another with respect to the first direction, at least one integrated second cooling duct extending from the third to the fourth end region, a second coolant supply opening fluidically connected to the at least one second cooling duct and arranged in the third end region, and a second coolant discharge opening fluidically connected to the at least one second cooling duct and arranged in the fourth end region.

The cooling plate unit thus comprises two cooling plates which are arranged next to one another in a second direction and which each comprise at least one cooling duct extending in the first direction. The invention is based on several findings: On the one hand, conventional inter-cell cooling units comprise only a single cooling plate for installation space reasons. If one now considers a structure consisting of a plurality of cells arranged next to one another in the second direction, wherein a single cooling plate is arranged between two cells arranged adjacent to one another in each case, a unidirectional flow of a cooling medium through all the cooling plates would result in the battery cells being cooled more intensely on the inlet side of the cooling medium than on the opposite outlet side. Attempts made so far to remedy this problem, however, have led to more and other problems. For example, a more complex, for example meander-shaped, cooling duct guide could be selected within a cooling plate. However, this enormously complicates the structure and manufacture of such an individual cooling plate. The flow through the cooling plates arranged in the respective intermediate spaces in the second direction could also be alternately in opposite directions. However, in order to provide a connection option for the coolant supply and discharge, it is then necessary to position the connections differently for the cooling plates through which flow occurs in a first direction than for the cooling plates through which flow occurs in opposite directions, which means that two different types of cooling plates or inter-cell cooling units must be provided in order to construct such a cooling system, which in turn complicates its structure and installation. By providing two cooling plates in a common cooling plate unit, on the other hand, it is advantageously possible to allow a coolant to flow through the two cooling plates in opposite directions during operation of the inter-cell cooling unit. As a result, the manufacture of the individual cooling plates is particularly simple, since above all the course of the cooling ducts within the respective cooling plates can be of a very simple design. Above all, however, cell rows can be cooled particularly homogeneously as a result, and the temperature spread mentioned at the outset can be avoided or at least reduced. At the same time, the combination of two cooling plates in a common cooling unit also makes it possible, when using a plurality of such inter-cell cooling units, for example in a battery, to provide these as identical parts to a plurality of inter-cell cooling units. In other words, this design makes it possible to provide a geometrically identical inter-cell cooling unit in each intermediate space between two cells or cell rows. In such a design, it is therefore not necessary to arrange two differently designed inter-cell cooling units alternately in order to achieve homogeneous cell cooling. This in turn greatly simplifies the structure and installation of such a cooling system. Thus, the inter-cell cooling unit according to the invention advantageously makes it possible to cool cells as uniformly as possible and at the same time to provide the simplest possible structure of a cooling system.

In principle, the first and the second cooling plates can be designed similarly or identically. The features and properties described with reference to the first cooling plate can therefore also apply analogously to the second cooling plate. The two cooling plates can in particular be joined together, for example by bonding, welding, hot caulking, and so on. The fact that the first cooling plate comprises at least one integrated first cooling duct is to be understood as meaning that a cooling medium which is guided through this first cooling duct is guided through the interior of the first cooling plate and, above all, has no contact with a battery cell, in particular not with a cell housing of such a battery cell. The cooling duct integrated into the first cooling plate is thus defined by the first cooling plate alone. The first cooling plate may also comprise a plurality of first cooling ducts. The same applies to the second cooling plate. The at least one first cooling duct can run in a straight line in the first direction or in some regions also not in a straight line. If the first cooling plate comprises a plurality of cooling ducts, it is preferred that these extend parallel to one another.

The second direction mentioned above can additionally be defined perpendicular to said first direction. In addition, as will be explained in more detail later, a third direction perpendicular to the first and second directions may also be defined for the sake of simplifying the description.

For example, the first cooling plate may comprise a first outer surface facing away from the second cooling plate, and the second cooling plate may have a second outer surface facing away from the first cooling plate, wherein the first and second outer surfaces are substantially flat. This advantageously permits a flat contact with adjacent battery cells having likewise flat or essentially flat housing sides. This enables particularly efficient cooling of the adjacent battery surfaces due to the resulting large-area contact. The first and second cooling plates can also have inner surfaces facing each other, for example the first cooling plate can have a first inner surface and the second cooling plate can have a second inner surface. These do not have to be in direct contact with each other, but they still may. There may also be an intermediate space between these two inner surfaces. In addition, the inner surfaces need not necessarily be flat, but they still may. In the third direction, the inner surfaces may also be designed to extend in a zigzag-shaped or wave-shaped manner.

For example, the first cooling plate can comprise a first wall and a second wall between which the at least one first cooling duct is formed, wherein the first wall provides the first outer surface and the second wall provides the first inner surface. The same can apply to the second cooling plate. Due to a corrugated or zigzag-shaped configuration of the respective inner surface, a plurality of cooling ducts arranged next to one another in a third direction can readily be integrated into a respective cooling plate in a simple manner.

Furthermore, it is very advantageous if the cooling plates are made of a metallic material, for example aluminum. As a result, very good thermal conductivity can be provided by the cooling plates, which in turn explains good cooling of the adjacent battery cells when using the inter-cell cooling unit in a battery.

Another advantage of this is that the inter-cell cooling unit can also be used in the same way or only in a slightly modified manner as a starting or end plate without having to fundamentally change the structure or the geometrical design of the inter-cell cooling unit for this purpose. This additionally reduces the variance of the system design, and tools and manufacturing costs can be further reduced.

In a particularly advantageous embodiment of the invention, the first and second cooling plates are designed as identical parts. In other words, in this case the first and the second cooling plate are geometrically identical. This further simplifies the manufacture of the inter-cell cooling unit. Thus, it is also not necessary to provide two cooling plates of different geometrical design in order to provide the inter-cell cooling unit.

According to a further very advantageous embodiment of the invention, the second cooling plate is arranged rotated by 180° with respect to the first cooling plate about a first axis of rotation which extends parallel to the first direction or about a third axis of rotation which extends parallel to a third direction. As mentioned above, the third direction can be defined perpendicular to the first and second directions. The first and second cooling plates can therefore be geometrically identical, that is, designed as identical parts, and for the installation of the cooling plates in the cooling unit only the second cooling plate is then rotated by 180°, either parallel to the first direction or parallel to the third direction, for example. This rotated positioning of the cooling plates relative to one another enables particularly efficient positioning of the coolant supply and discharge connections. The first and the second cooling plate can be designed such that the first cooling plate can be imaged onto the second cooling plate by a 180° rotation about the first axis of rotation. Alternatively or additionally, the first and the second cooling plate can be geometrically designed such that the first cooling plate can be imaged onto the second cooling plate by a 180° rotation about the third axis of rotation. The first and the second cooling plate can also be designed such that the first cooling plate can be imaged onto the second cooling plate by a 180° rotation about the first axis of rotation only but not by a 180° rotation about the third axis of rotation. This in turn depends on the specific geometrical design of the respective cooling plates as such, as will be explained in more detail later.

The rotated positioning of the second cooling plate relative to the first cooling plate results in a certain symmetry of the entire cooling plate unit as such. In particular, the cooling plate unit is symmetrical with respect to a geometrical design of the first and second cooling plates and with respect to the arrangement of the first and second cooling plates symmetrically to one another with respect to a rotation of the cooling plate unit by 180°about the first axis of rotation and/or about a second axis of rotation which runs parallel to the second direction, and/or about a third axis of rotation. In other words, the cooling plate unit is designed symmetrically in such a way that a rotation of this cooling plate unit by 180°about the first axis of rotation or about the second axis of rotation or about the third axis of rotation once again results in an identical cooling plate unit. This simplifies installation of the cooling plate unit, since no special orientation needs to be taken into account.

According to a further advantageous embodiment of the invention, the first cooling plate comprises a first offset region which is arranged between a first and a second extension region of the first cooling plate with respect to the first direction, wherein the at least one first cooling duct runs in the first extension region at a first height with respect to a third direction which is perpendicular to the first and second directions, and runs in the second extension region at a second height which is lower than the first height with respect to the third direction, and runs in the first offset region from the first height to the second height. The at least one first cooling duct thus has a downward vertical offset in its course in the first direction in the offset region. The second cooling plate can be designed with a complementary offset of its at least one second cooling duct, in particular with respect to its rotated installation position. In other words, the second cooling plate can again be geometrically identical to the first cooling plate, also with respect to the course of the at least one second cooling duct. The rotation of the second cooling plate by 180° about the first or third axis of rotation then results in a complementary offset of the at least one second cooling duct. The first cooling duct can then have a vertical offset downwards in the first direction, and the second cooling duct can have a vertical offset upwards in the course of the first direction, or vice versa.

Therefore, it is a further advantageous embodiment of the invention if the second cooling plate comprises a second offset region which is opposite the first offset region with respect to the second direction and which is arranged with respect to the first direction between a third extension region opposite the first extension region in the second direction and a fourth extension region of the second cooling plate opposite the second extension region in the second direction, wherein the at least one second cooling duct extends in the third extension region at a third height with respect to the third direction, and extends in the fourth extension region at a fourth height higher than the third height with respect to the third direction, and extends in the second offset region from the third height to the fourth height, in particular wherein the first and third heights are not equal and the second and fourth heights are not equal. If, therefore, the at least one first cooling duct decreases in its course in the first direction in the offset region from the first height to the second height, the at least one second cooling duct, on the other hand, increases in its course in the first direction from the third height to the fourth height. Referring to a top view of these cooling duct courses in the second direction, the first and the second cooling duct intersect in particular in the offset region. As a result, further advantageous symmetry properties of the cooling plate unit can be implemented. In particular, this makes it possible for the cooling plate unit to be imaged onto itself during a rotation by 180° about the above-defined first axis of rotation. In the same way, the first cooling plate can thereby be imaged onto the second cooling plate, or vice versa, both in the case of a rotation by 180° about the first axis of rotation and in the case of a rotation by 180°about the third axis of rotation. This allows a particularly simple design of the cooling plate unit and the inter-cell cooling unit as a whole. If a respective cooling plate in turn has a plurality of cooling ducts, these ducts extend to the first end region and to the second end region in turn preferably parallel to one another and all have the same offset in the respective offset region.

Alternatively, the respective cooling ducts can also be designed to extend in a straight line in the first direction, that is, without any offset. This simplifies the design of the respective cooling plates.

The first and third heights are preferably not the same, and the second and fourth heights are preferably different as well. In general, it is preferred that the first cooling ducts are offset relative to the second cooling ducts in the third direction, at least in the respective mutually corresponding extension regions or relative to their entire course in the first direction, if these run completely in a straight line in the first direction without offset. The offset of the first cooling ducts relative to the second cooling ducts can correspond, for example, to half the distance between two first cooling ducts adjacent in the third direction or second cooling ducts adjacent in the third direction. This has the great advantage that the at least one first cooling duct is not directly opposite the at least one second cooling duct with respect to the second direction. This, in turn, would have the disadvantage that the cooling ducts would be pressed onto one another and possibly deformed in the event of cell swelling, that is, expansion of the adjacent battery cells as a result of aging or as a result of charging. Such direct pressing onto each other can be avoided by the mutually offset course of the ducts. If the respective cooling plates have a respective offset region as described above, it is preferred that this is adjacent to a region of an adjacent cell row with a plurality of battery cells, which region corresponds to an inter-cell region between two battery cells of a same cell row adjacent to one another in the first direction. No cell swelling therefore takes place in this region, so that such an offset region is also not subjected to any external force application caused by swelling with respect to the second direction. This advantageously prevents the channels from being pressed together in such offset regions.

The first and second offset regions are preferably located in the center of the first or second cooling plate, respectively, with respect to the first direction.

According to an advantageous embodiment of the invention, an intermediate layer which can be elastically compressed in the second direction is arranged between the first and second cooling plates. Such an intermediate layer can advantageously compensate for the above-mentioned cell swelling. The intermediate layer is therefore resilient due to its elastic compressibility. Pressing the cooling plate unit together with respect to the second direction thus substantially does not lead to compression of the cooling ducts, but instead to compression of this elastically compressible intermediate layer. As a result, the cooling ducts can additionally be protected against compression. The provision of such an intermediate layer is specifically advantageous in combination with the first and second cooling ducts, which are offset relative to one another with respect to the third direction, since this offset allows the intermediate layer to be positioned between the two cooling plates in a significantly more space-efficient manner. The intermediate layer can also be flexible. For example, a layer of a foam, in particular plastic foam, can be used as the intermediate layer. Between the individual cooling plates, that is, the first and second cooling plates, an additional foam can therefore also be used which absorbs the swelling forces and/or swelling paths of the cells.

This foam layer can also extend over the entire intermediate space between the two cooling plates in the first direction. Alternatively, a plurality of such intermediate layers can be arranged in sections next to one another in the first direction. These can optionally also have a spacing in the first direction. For example, such an intermediate layer does not necessarily also have to be provided between the above-defined first and second offset regions, since, as described, swelling compensation is not necessarily required in this region.

According to a further advantageous embodiment of the invention, the first cooling plate comprises two first plate walls which delimit the cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame. The second cooling plate can in turn be designed in the same way. A first plastic frame can therefore be arranged on the first cooling plate and a second plastic frame can be arranged on the second cooling plate, for example analogously. The first plastic frame can be injection molded onto the edge of the first cooling plate, for example. The individual cooling plates may consist of a metallic cooling body which is encapsulated by a plastic frame, for example. The plastic frame can advantageously also be accompanied by additional functional components, for example cooling water nozzles, relief bores, latches or pins. This allows additional functions to be integrated into the plastic frame. In addition, seals can be injection molded in the injection molding process in which the plastic frame is joined to the respective cooling plate. The system constructed in this way, in particular the respective cooling plate with its attached plastic frame, has the advantage that this system is constructed redundantly with respect to leak tightness. The first sealing plane can be provided, for example, by the joining connection between the two walls of the cooling plate in the joining region and the second sealing plane by the injection-molded frame in which the joining region can be embedded.

It is also conceivable that first the first cooling plate and the second cooling plate are joined together with optional embedding of the intermediate layer between them, for example by bonding, welding, hot caulking or the like, and then a common plastic frame is injection molded on the edge where the joint connection is embedded between the two cooling plates. Such a plastic frame can also be designed with the above-mentioned optional further functional elements, namely coolant supply and discharge ports, in particular in the form of cooling water nozzles, relief bores, latches, pins, and the like.

Furthermore, the invention also relates to a cooling arrangement having a first inter-cell cooling unit according to the invention or one of its embodiments.

In a further advantageous embodiment of the cooling arrangement, the cooling arrangement comprises at least one row of cells with at least one battery cell, wherein the row of cells is arranged in the second direction next to the first inter-cell cooling unit and the at least one battery cell adjoins the first or second cooling plate in a planar manner. This allows particularly efficient cooling of the battery cells. Preferably, at least one row of cells comprises a plurality of battery cells which are arranged next to one another in the first direction. In this case, the battery cells on the same row of cells do not face one another with their largest sides in terms of area, but, for example, with their respective end faces on which a cell pole can be located in each case. The cell poles of two adjacent battery cells facing each other on the same cell row can be electrically contacted with one another, for example via a cell connector. The region in which the two cell poles of two adjacent battery cells are arranged and/or the region between these cell poles can represent the above-defined inter-cell region.

The cooling arrangement can also comprise a plurality of cell rows arranged next to one another in the second direction, wherein an inter-cell cooling unit according to the invention or one of its embodiments can be arranged in a respective intermediate space between two cell rows adjacent to one another in the second direction. An inter-cell cooling unit can also be arranged in the second direction after the last cell row and/or in front of the first cell row.

In addition, the battery cells can be designed as prismatic battery cells, for example. In particular, the battery cells can be lithium-ion cells. A battery, in particular a high-voltage battery, can be provided by the cooling arrangement, in particular with a plurality of such cell rows. The battery can be configured as a traction battery for a motor vehicle.

According to a further advantageous embodiment of the invention, the cooling arrangement comprises a second inter-cell cooling unit, wherein the first and second inter-cell cooling units are designed as identical parts. Each of these inter-cell cooling units can be arranged in an intermediate space between two cell rows adjacent to one another in the second direction.

inter-cell cooling units of identical geometry can therefore be provided in each intermediate space. This simplifies the manufacture of the cooling arrangement and the battery.

Furthermore, the invention also relates to a motor vehicle having an inter-cell cooling unit according to the invention or one of its embodiments or having a cooling arrangement according to the invention or one of its embodiments.

The motor vehicle according to the invention is preferably designed as an automobile, in particular as a passenger car or truck, or as a passenger bus or motorcycle. The motor vehicle may be designed as an electric vehicle.

The invention further relates to a method for operating an inter-cell cooling unit according to the invention or one of its embodiments, wherein a coolant flows through the at least one first cooling duct and the at least one second cooling duct in opposite directions of flow. This enables particularly uniform cooling of the adjacent battery cells. In operation, the inter-cell cooling unit can be arranged between two cell rows, each with at least one battery cell.

A coolant can for example be supplied to the first cooling plate and the second cooling plate through the first coolant supply opening and the second coolant supply opening and can be discharged again through the first coolant discharge opening and the second coolant discharge opening. A corresponding coolant supply port and coolant discharge port can be attached, in particular injection-molded, to the coolant supply openings and the coolant discharge openings, in particular via the plastic frames described above.

Furthermore, the invention also relates to a method for producing an inter-cell cooling unit for arrangement between two cell rows, each having at least one battery cell, wherein the inter-cell cooling unit comprises a cooling plate unit which has a first cooling plate which in turn comprises a first and a second end region which are opposite one another with respect to a first direction, at least one integrated first cooling duct extending from the first to the second end region, a first coolant supply opening fluidically connected to the at least one first cooling duct and arranged in the first end region, and a first coolant discharge opening fluidically connected to the at least one first cooling duct and arranged in the second end region. Furthermore, a second cooling plate is provided which comprises a third and a fourth end region which are opposite one another with respect to the first direction, at least one integrated second cooling duct extending from the third to the fourth end region, a second coolant supply opening fluidically connected to the at least one second cooling duct and arranged in the third end region, and a second coolant discharge opening fluidically connected to the at least one second cooling duct and arranged in the fourth end region. In addition, the second cooling plate is arranged next to the first cooling plate with respect to a second direction.

It is also particularly advantageous if the first and second cooling plates are provided as identical parts and the second cooling plate is arranged rotated by 180°relative to the first cooling plate about an axis of rotation parallel to the first direction or about an axis of rotation parallel to a third direction. This allows a particularly simple design of the inter-cell cooling unit.

The invention also includes further developments of the method according to the invention, which have features as already described in the context of the further developments of the inter-cell cooling unit according to the invention, the cooling arrangement according to the invention, and the motor vehicle according to the invention. For this reason, the corresponding further developments of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows an exploded schematic representation of an inter-cell cooling unit according to a further exemplary embodiment of the invention;

FIG. 2 shows a schematic representation of an inter-cell cooling unit according to an exemplary embodiment of the invention;

FIG. 3 shows a schematic and perspective representation of an inter-cell cooling unit according to an exemplary embodiment of the invention;

FIG. 4 shows a schematic cross-sectional representation of an inter-cell cooling device according to an exemplary embodiment of the invention;

FIG. 5 shows a schematic representation of an end cooling unit for a cooling arrangement according to an exemplary embodiment of the invention;

FIG. 6 shows a schematic and perspective representation of an inter-cell cooling unit according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by others of the above-described features of the invention.

In the figures, same reference numerals respectively designate elements that have the same function.

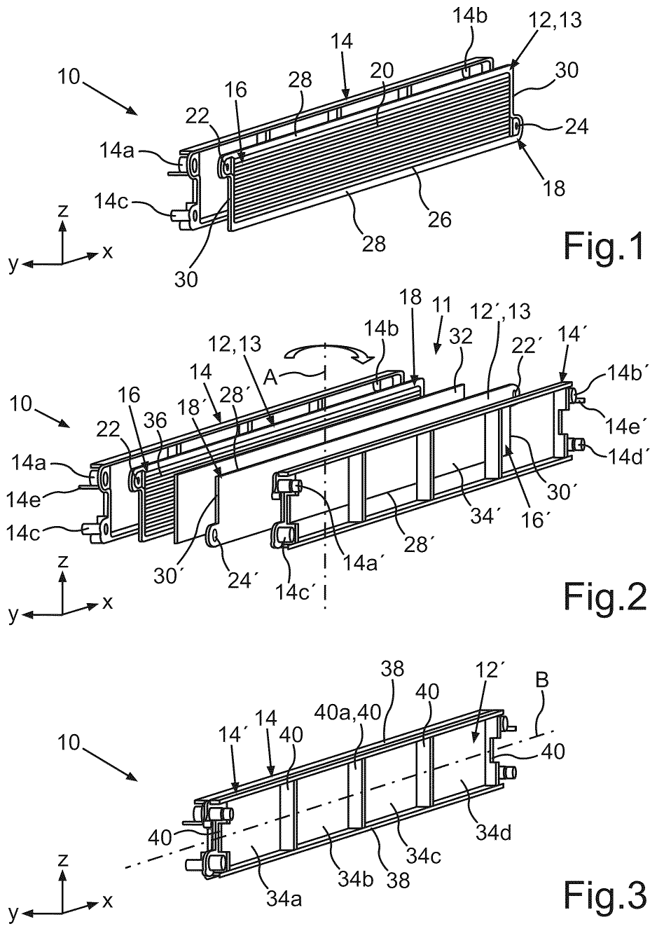

FIG. 1 shows a schematic representation of at least a part of an inter-cell cooling unit 10 according to an exemplary embodiment of the invention. In the present case, only a first cooling plate 12 and a plastic frame 14 are shown on this inter-cell cooling unit 10, which frame is joined to the cooling plate 12, for example, can be injection molded onto the cooling plate 12 in an injection molding process. The cooling plate 12 itself is preferably made of a metallic material. The cooling plate 12 also has two end regions 16, 18 which are opposite one another with respect to the x-direction shown. In addition, the cooling plate 12 comprises integrated cooling channels 20 which extend from the first end region 16 to the second end region 18. In the present example, the cooling ducts 20 run in a straight line. Furthermore, the cooling plate 12 has a first opening 22, for example a first coolant supply opening 22, in the first end region 16, and a second opening 24, for example a coolant discharge opening, in the second end region 18. Alternatively, however, a coolant can also be supplied via the second opening 24 of the cooling plate 12, in particular its cooling ducts 20, and the supplied coolant can be discharged again from the opening 22.

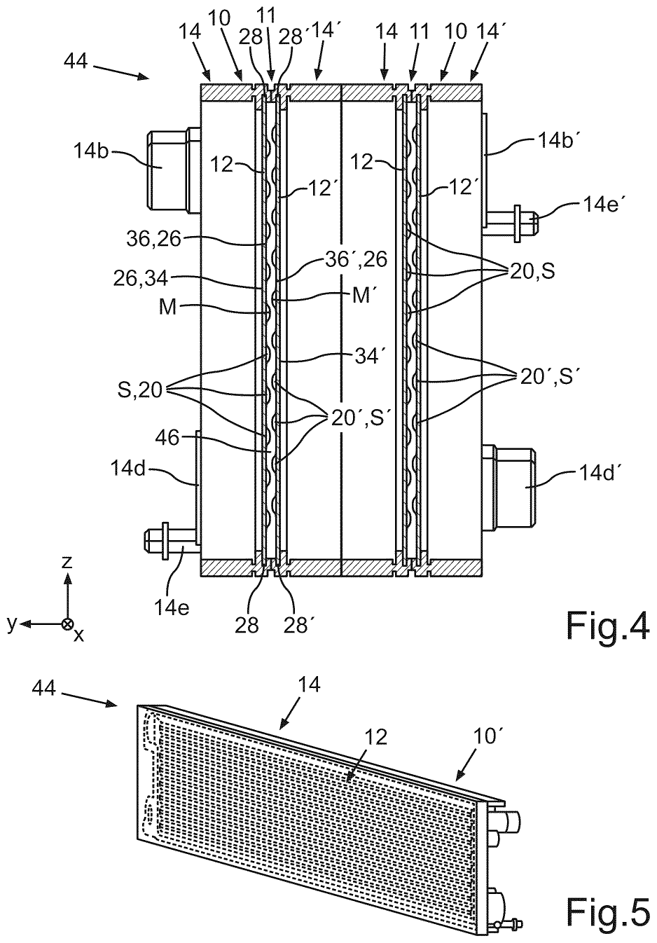

The cooling plate 12 may comprise two walls 26 which delimit the cooling plate 12 in and against the y-direction and which may be joined to one another in an edge region 28, for example may be welded to one another. In particular, the walls 26 can be joined to one another only in the edge regions 28 extending in the x-direction and lying opposite one another with respect to the z-direction, or can also be joined along the entire circumference, i.e., also in the edge regions 30 lying opposite one another with respect to the x-direction. The aforementioned plastic frame 14 can be injection molded onto the edge of the cooling plate 12, in particular only in sections or completely all around the cooling plate 12. At least the joining regions 28 extending in the x-direction, in which the two walls 26 of the cooling plate 12 are joined to one another, are embedded in the plastic of the plastic frame 14. As a result, a second sealing plane can be created and the leak tightness of this arrangement can be additionally increased. Advantageously, further functional components can be provided by the frame 14, for example a coolant supply port 14a for the first cooling plate 12, a coolant discharge port 14d (see FIG. 4) for the first cooling plate 12, which in the present illustration, however, is covered by the cooling plate 12 itself, a coolant supply port 14b for the second cooling plate 12′ (see FIG. 2) explained in more detail later, and a coolant discharge port 14c for the second cooling plate 12′. These ports 14a, 14b, 14c, 14d may be provided in the form of nozzles.

FIG. 2 shows a schematic and perspective representation of an inter-cell cooling unit 10 according to an exemplary embodiment of the invention. In addition to the components already described for FIG. 1, the inter-cell cooling unit 10 also comprises the already mentioned second cooling plate 12′ and a second frame 14′ assigned thereto. In addition, an intermediate layer 32 which is elastically compressible is optionally arranged between the two cooling plates 12, 12′ in the y-direction. For example, this layer can be designed as a plastic foam layer 32. The first cooling plate 12 also has an outer surface 34 (see FIG. 4) which is not visible in the present case, and the second cooling plate 12′also has an outer surface 34′which faces away from the first cooling plate 12 and which is preferably flat. This enables flat abutment on the adjacent battery cell. The respective inner surfaces 36, 36′ (see FIG. 4) of the cooling plates 12, 12′, of which only the inner surface 36 of the first cooling plate 12 can be seen in FIG. 2, on the other hand, may be corrugated or not planar to form the cooling channel structure. The second cooling plate 12′ can also comprise two end regions 16′, 18′, in which there is in each case a coolant supply opening 22′ and a coolant discharge opening 24′, as well as one or more cooling ducts 20′ (see FIG. 4) which extend from one end region 16′, 18′ to the other.

It is particularly advantageous if the second cooling plate 12′ is designed geometrically identical to the first cooling plate 12 and is oriented differently from the first cooling plate 12 only with respect to its installation position. In the present example, the second cooling plate 12′ is rotated with respect to the first cooling plate 12 about the axis A shown, which was also previously designated as the third axis. The two cooling plates 12, 12′ can therefore advantageously be designed as an identical part 13. The two cooling plates 12, 12′ are therefore the same component, which is only installed in a different orientation.

Alternatively or additionally, the second cooling plate 12′ can also be installed rotated by 180° with respect to its installation position about an axis of rotation B parallel to the x-direction (see FIG. 3).

The second frame 14′ may be designed with the same functional elements as those already described with reference to FIG. 1. In particular, this frame 14′ also comprises four coolant ports 14a′, 14b′, 14c′ and 14d′.

The second cooling plate 12′ can therefore also comprise a first opening 22′, for example a coolant supply opening 22′, as well as a second opening 24′, for example a coolant discharge opening. It is particularly advantageous in this case if the supply openings 22, 22′ of the two cooling plates 12, 12′ are arranged at different ends of the cooling plate unit 11 which comprises these two cooling plates 12, 12′ with respect to the x-direction, and also the discharge openings 24, 24′. As a result, the coolant flows through the cooling plates 12′ in the opposite direction during operation. This enables particularly uniform cooling of the adjacent battery cells.

In the assembled or finished state of the inter-cell cooling unit 10, as shown schematically in FIG. 3, the two nozzles 14a, 14a′ of the two frames 14, 14′ are coupled to the supply opening 22 of the first cooling plate, the nozzles 14c, 14c′ are coupled to the discharge opening 24′ of the second cooling plate 12′, the nozzles 14b, 14b′ are coupled to the supply opening 22′ of the second cooling plate 12′, and the nozzles 14d′, as well as the corresponding nozzle 14d of the first frame 14, which is not to be seen, is coupled to the discharge opening 24 of the first cooling plate 12. The coolant is supplied via the nozzles 14a, 14a′ and the nozzles 14b, 14b′ into the respective cooling plates 12, 12′ and the coolant is discharged from the respective cooling plates 12, 12′ via the nozzles 14c, 14c′ and 14d, 14d′. The nozzles 14a, 14a′, 14b, 14b′, 14c, 14c′, 14d, 14d′ can each be fluidically connected to corresponding nozzles 14a, 14a′, 14b, 14b′, 14c, 14c′, 14d, 14d′ of an inter-cell cooling unit 10 arranged adjacent in and/or against the y direction, in particular by means of a plug connector in the y direction and thus correspondingly form coolant supply lines and coolant discharge lines.

A drainage channel 14e, 14e′ can optionally also be provided via the frames 14, 14′. Further functional elements such as latching lugs, latching elements and the like can also be provided via the frames 14, 14′, although not explicitly shown.

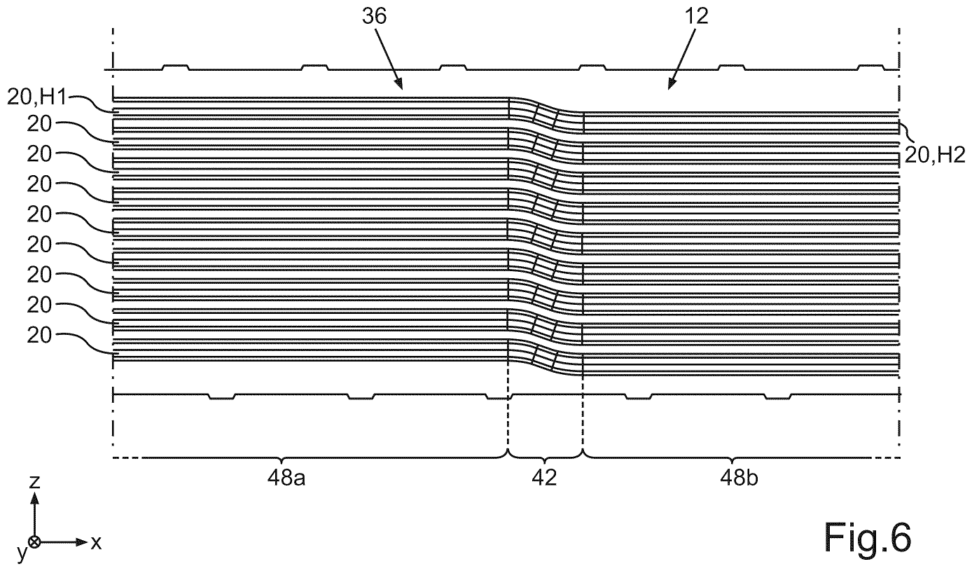

As mentioned above, FIG. 3 shows a schematic and perspective representation of an inter-cell cooling unit 10 according to an exemplary embodiment of the invention. This can be designed as described above and is shown here in the finished or assembled state. The inter-cell cooling unit 10 is intended to be positioned between cell rows which each comprise a plurality of battery cells. For this reason, the outer surfaces 34′ of the respective cooling plates 12, 12′ can be divided into a plurality of cooling regions 34a, 34b, 34c, 34d in the x-direction, in the present example four such cooling regions. The outer surface of the corresponding first cooling plate 12 can be designed in the same way, although this is not visible here either. Each of these cooling regions 34a, 34b, 34c, 34d is assigned exactly one battery cell of the cell row on which the inter-cell cooling unit 10 is to be arranged. In the state arranged in accordance with the intended purpose, a respective cooling region 34a, 34b, 34c, 34d therefore lies flat on the associated housing side of the associated battery cell. The frames 14, 14′ can also be divided into different sections, as explained below with reference to the second frame 14′. The first frame 14 can be constructed in a completely analogous manner. The second frame 14′ comprises two longitudinal sections 38 extending in the x-direction and lying opposite one another with respect to the z-direction, which are connected via connecting sections 40 of the frame 14′ which extend in the z-direction and extend parallel to one another. These connecting sections 40, in particular the connecting sections 40 on the edge side with respect to the x-direction, come to rest, for example, on the respective edge regions 30′ of the second cooling plate 12′, and the longitudinal sections 38 come to rest in the joining regions 28′ of the second cooling plate 12′. The non-edge-side connecting webs 40 are arranged on the outer surface 34′ of the cooling plate 12′, specifically in a region which is located in each case between two adjacent cooling regions 34a, 34b, 34c, 34d. The offset regions 42 of the respective cooling plates 12, 12′, which are explained in more detail later with reference to FIG. 6, can be directly opposite the connecting web 40a, which is central in the x-direction, with respect to the y-direction.

If a plurality of such inter-cell cooling units 10 are arranged next to one another in and/or against the y-direction, then intermediate spaces are formed by the frames 14, 14′ which then adjoin one another in the area of the cooling regions 34a, 34b, 34c, 34d, in which intermediate spaces battery cells can be arranged or, in the case of intended use of the inter-cell cooling units 10, are arranged in a battery. These battery cells are correspondingly housed in by the frames 14, 14′.

FIG. 4 shows a schematic cross-sectional representation of a cooling arrangement 44 with two inter-cell cooling units 10 arranged next to one another according to an exemplary embodiment of the invention. The inter-cell cooling units 10 can be identical to one another and in particular designed as described above. Accordingly, only one of these inter-cell cooling units 10 is described below. In particular, the first cooling ducts 20 of the first cooling plate 12 and the second cooling ducts 20′ of the second cooling plate 12′ can be seen here. These are advantageously arranged offset relative to one another in the z direction. This permits an arrangement which is efficient in terms of installation space, especially in the y direction, and it is possible to avoid that the cooling ducts 20, 20′ are pressed directly onto one another in the course of swelling. In addition, this arrangement advantageously results in clearances 46 between the cooling plates 12, 12′, which can advantageously be used to provide the intermediate layer 32 described with respect to FIG. 2. The maximum elevations of the first cooling plate 12 with respect to the outer surface 34 of the first cooling plate 12 are denoted by M, and the corresponding maximum elevations of the second cooling plate 12′ with respect to its outer surface 34′ are denoted by M′. The maximum elevations M′ of the second cooling plate 12′ are preferably located in the middle between two maximum elevations M of the first cooling plate 12 and vice versa with respect to the z direction (except for the edge-side cooling ducts). The maximum elevations M, on the one hand, and the maximum elevations M′, on the other hand, are therefore offset relative to one another with respect to the z direction, i.e., are not at the same height.

Such an arrangement of the cooling ducts 20, 20′ is preferred both for a cooling plate unit 11, the cooling plates 12, 12′ of which exclusively comprise cooling ducts 20, 20′ extending in a straight line in the x-direction, and also for a cooling plate unit 11 which comprises cooling plates 12, 12′ with a respective offset region 42 (see FIG. 6). This described offset of the cooling ducts 20, 20′ is then implemented at least in the regions of the cooling plates 12, 12′ which are different from the offset region 42, in particular in the respective extension regions 48a, 48b (see FIG. 6), of the respective cooling plates 12, 12′ in which the cooling ducts 20, 20′ each run in a straight line in the x direction.

In addition, the flow direction assigned to the first cooling ducts 20 is designated by S, and the flow direction assigned to the second cooling ducts 20′ is designated by S′. The flow directions S, S′ are opposite to one another. The direction of flow S can, for example, run in the x-direction, while the direction of flow S′ runs against the x-direction shown.

FIG. 5 shows a schematic representation of a part of a cooling arrangement 44 according to an exemplary embodiment of the invention. In particular, an end plate unit 10′ is shown here, which can be provided as half of an inter-cell cooling unit 10, so to speak. This therefore has only a single cooling plate 12 and a frame 14 arranged thereon, as already described in FIG. 1, for example. Thus, the modified inter-cell cooling unit 10 can also be advantageously used as an end plate unit 10′. In particular, such end plate units 10′ can be provided in and against the y-direction as first and last end plate units 10′ of a cooling arrangement 44.

FIG. 6 shows a schematic representation of a part of a cooling plate 12, 12′ in a schematic plan view on the inner surface 36. The properties and features described below can apply analogously to the second cooling plate 12′. The course of the cooling ducts 20 can be seen in particular. The cooling plate 12 can be divided in particular into a plurality of regions, namely an offset region 42 and at least two extension regions 48a, 48b, wherein the offset region 42 is located between the two extension regions 48a, 48b. In the extension regions 48a, 48b, the cooling ducts each run in a straight line and parallel to one another in the x-direction. A duct height can be associated with a respective cooling duct 20. This height is defined with respect to the z direction. In the present example, a respective cooling duct 20 has an associated first duct height H1 in the first extension region 48a, which is illustrated here only for one of the cooling ducts 20. In the offset region 42, the duct height of a respective cooling duct 20 is reduced to a second duct height H2.

As already described, the second cooling plate 12′ may be identical to the first cooling plate 12. However, the second cooling plate 12′ is installed rotated by 180 degrees relative to the first cooling plate 12, for example about the third axis A or the first axis B. As a result, when the two cooling plates 12, 12′ are located opposite one another in the y-direction, the corresponding cooling ducts 20′ of the second cooling plate 12′ increase in height in the offset region 42. In other words, the respective cooling ducts 20, 20′ intersect in the offset region 42. This permits particularly uniform and symmetrical cooling of the adjacent cells. In the extension regions 48a, 48b, the cooling ducts 20, 20′ can again be arranged such that they are offset relative to one another in the z-direction. The intersection in the offset region 42 is not relevant with respect to cell swelling, since no compression of the cooling plate unit 11 takes place in this case since the offset region 42, as already described with respect to FIG. 3, is located in the region of the intermediate webs 40, for example of the central intermediate web 40a of the frame 14′ which is located between two battery cells.

Overall, the examples show how the invention can provide a cross-cooler as an inter-cell cooling device in the form of the inter-cell cooling unit described. By using the described cross-cooling system, coolant can flow to the series-connected cells from two different sides. Advantageously, not every second cooling plate has coolant flown through from the other side, instead the cross flow is converted within an assembly cooling plate which has also been referred to as a cooling plate unit in this document. The assembly cooling plate preferably comprises two rotationally symmetrical individual cooling plates. These can be connected to one another. Bonding and/or welding and/or hot caulking can be used as the joining technique. Depending on the embodiment, rotation can take place about the vertical or longitudinal axis, which were previously also referred to as the third axis of rotation and the first axis of rotation. The individual cooling plates themselves consist of a metallic cooling body which is encapsulated by a plastic frame, for example. The plastic frame can advantageously also be accompanied by additional functional components, for example cooling water supports, relief bores, latches, or pins. In addition, seals can be injection molded thereto during the injection molding process. The cooling system constructed in this way has the advantage that it is constructed redundantly with respect to leak tightness. A further advantage of the cooling system is that the individual cooling plates can be used both for the construction of the assembly cooling plates and for the start and end plates. This reduces variance, tool and production costs. An additional foam can therefore also be used between the individual cooling plates, which foam absorbs the swelling forces and/or swelling paths of the cells.

1. An inter-cell cooling unit for arrangement between two cell rows, each with at least one battery cell, wherein the inter-cell cooling unit comprises a cooling plate unit which has a first cooling plate, comprising:
a first and a second end region, which are opposite one another with respect to a first direction,
at least one integrated first cooling duct extending from the first to the second end region,
a first coolant supply opening fluidically connected to the at least one first cooling duct and arranged in the first end region, and
a first coolant discharge opening fluidically connected to the at least one first cooling duct and arranged in the second end region,
characterized in that
the cooling plate unit comprises a second cooling plate which is arranged next to the first cooling plate with respect to a second direction and which comprises
a third and a fourth end region, which are opposite one another with respect to the first direction,
at least one integrated second cooling duct extending from the third to the fourth end region,
a second coolant supply opening fluidically connected to the at least one second cooling duct and arranged in the third end region, and
a second coolant discharge opening fluidically connected to the at least one second cooling duct and arranged in the fourth end region.

2. The inter-cell cooling unit according to claim 1, wherein the first and second cooling plates are designed as identical parts.

3. The inter-cell cooling unit according to claim 1, wherein the second cooling plate is arranged rotated by 180° with respect to the first cooling plate
about a first axis of rotation which is parallel to the first direction; or
about a third axis of rotation which is parallel to a third direction perpendicular to the first and second directions.

4. The inter-cell cooling unit according to claim 1, wherein
the first cooling plate comprises a first offset region which is arranged between a first and a second extension region of the first cooling plate with respect to the first direction, wherein the at least one first cooling duct runs in the first extension region at a first height with respect to a third direction which is perpendicular to the first and second directions, and runs in the second extension region at a second height which is lower than the first height with respect to the third direction, and runs in the first offset region from the first height to the second height; and
the second cooling plate comprises a second offset region which is opposite the first offset region with respect to the second direction and which is arranged with respect to the first direction between a third extension region opposite the first extension region in the second direction and a fourth extension region of the second cooling plate opposite the second extension region in the second direction, wherein the at least one second cooling duct extends in the third extension region at a third height with respect to the third direction, and runs in the fourth extension region at a fourth height higher than the third height with respect to the third direction, and runs in the second offset region from the third height to the fourth height, in particular wherein the first and third heights are not equal and the second and fourth heights are not equal.

5. The inter-cell cooling unit according to claim 1, wherein an intermediate layer which can be elastically compressed in the second direction is arranged between the first and second cooling plates.

6. The inter-cell cooling unit according to claim 1, wherein the first cooling plate comprises two first plate walls which delimit the first cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame.

7. A cooling arrangement with a first inter-cell cooling unit according to claim 1, wherein
the cooling arrangement comprises at least one row of cells with at least one battery cell, wherein the row of cells is arranged in the second direction next to the first inter-cell cooling unit and the at least one battery cell adjoins the first or second cooling plate in a planar manner; and/or
the cooling arrangement comprises a second inter-cell cooling unit, and the first and second inter-cell cooling units are designed as identical parts.

8. A motor vehicle with an inter-cell cooling unit according to claim 1.

9. A method for operating an inter-cell cooling unit according to claim 1, which is arranged between two cell rows, each having at least one battery cell,
wherein a coolant flows through the at least one first cooling duct and the at least one second cooling duct in opposite directions of flow.

10. An inter-cell cooling unit for arrangement between two cell rows, each with at least one battery cell, wherein a first cooling plate is provided, which comprises:
a first and a second end region, which are opposite one another with respect to a first direction,
at least one integrated first cooling duct extending from the first to the second end region,
a first coolant supply opening fluidically connected to the at least one first cooling duct and arranged in the first end region, and
a first coolant discharge opening fluidically connected to the at least one first cooling duct and arranged in the second end region,
wherein a second cooling plate is provided, which comprises
a third and a fourth end region, which are opposite one another with respect to the first direction,
at least one integrated second cooling duct extending from the third to the fourth end region,
a second coolant supply opening fluidically connected to the at least one second cooling duct and arranged in the third end region, and
a second coolant discharge opening fluidically connected to the at least one second cooling duct and arranged in the fourth end region,
wherein the second cooling plate is arranged next to the first cooling plate with respect to a second direction.

11. The inter-cell cooling unit according to claim 2, wherein the second cooling plate is arranged rotated by 180°with respect to the first cooling plate.

12. The inter-cell cooling unit according to claim 2, wherein
the first cooling plate comprises a first offset region which is arranged between a first and a second extension region of the first cooling plate with respect to the first direction, wherein the at least one first cooling duct runs in the first extension region at a first height with respect to a third direction which is perpendicular to the first and second directions, and runs in the second extension region at a second height which is lower than the first height with respect to the third direction, and runs in the first offset region from the first height to the second height; and
the second cooling plate comprises a second offset region which is opposite the first offset region with respect to the second direction and which is arranged with respect to the first direction between a third extension region opposite the first extension region in the second direction and a fourth extension region of the second cooling plate opposite the second extension region in the second direction, wherein the at least one second cooling duct extends in the third extension region at a third height with respect to the third direction, and runs in the fourth extension region at a fourth height higher than the third height with respect to the third direction, and runs in the second offset region from the third height to the fourth height, in particular wherein the first and third heights are not equal and the second and fourth heights are not equal.

13. The inter-cell cooling unit according to claim 3, wherein
the first cooling plate comprises a first offset region which is arranged between a first and a second extension region of the first cooling plate with respect to the first direction, wherein the at least one first cooling duct runs in the first extension region at a first height with respect to a third direction which is perpendicular to the first and second directions, and runs in the second extension region at a second height which is lower than the first height with respect to the third direction, and runs in the first offset region from the first height to the second height; and
the second cooling plate comprises a second offset region which is opposite the first offset region with respect to the second direction and which is arranged with respect to the first direction between a third extension region opposite the first extension region in the second direction and a fourth extension region of the second cooling plate opposite the second extension region in the second direction, wherein the at least one second cooling duct extends in the third extension region at a third height with respect to the third direction, and runs in the fourth extension region at a fourth height higher than the third height with respect to the third direction, and runs in the second offset region from the third height to the fourth height, in particular wherein the first and third heights are not equal and the second and fourth heights are not equal.

14. The inter-cell cooling unit according to claim 2, wherein an intermediate layer which can be elastically compressed in the second direction is arranged between the first and second cooling plates.

15. The inter-cell cooling unit according to claim 3, wherein an intermediate layer which can be elastically compressed in the second direction is arranged between the first and second cooling plates.

16. The inter-cell cooling unit according to claim 4, wherein an intermediate layer which can be elastically compressed in the second direction is arranged between the first and second cooling plates.

17. The inter-cell cooling unit according to claim 2, wherein the first cooling plate comprises two first plate walls which delimit the first cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame.

18. The inter-cell cooling unit according to claim 3, wherein the first cooling plate comprises two first plate walls which delimit the first cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame.

19. The inter-cell cooling unit according to claim 4, wherein the first cooling plate comprises two first plate walls which delimit the first cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame.

20. The inter-cell cooling unit according to claim 5, wherein the first cooling plate comprises two first plate walls which delimit the first cooling plate in and against the second direction and which are joined to one another at least in sections in a joining region in a first edge region which surrounds the first cooling plate at the edge, and the inter-cell cooling unit comprises a first plastic frame which is arranged at least in sections in the first edge region and in which at least a part of the joining region is embedded, in particular wherein a coolant supply port and/or a coolant discharge port is formed on the plastic frame.
